(19) United States
(12) Patent Application Publication
(10) Pub. No.: US 2012/0062533 A1
(43) Pub. Date: Mar. 15, 2012

(54) GATE DRIVER FOR USE IN A DISPLAY PANEL

(75) Inventor: MING-HAN TSAI, Taipei City (TW)

(73) Assignee: CHUNGHWA PICTURE TUBES, LTD., Bade City (TW)

(21) Appl. No.: 12/982,503

(22) Filed: Dec. 30, 2010

(30) Foreign Application Priority Data
Sep. 10, 2010 (TW) 099217609

(51) Int. Cl. G09G 5/00

(52) U.S. Cl. 345/205

(57) ABSTRACT

A gate driver capable of adjusting power consumption and output capability is proposed. The driving circuit includes a first metallic layer and a second metallic layer on the first metallic layer. The first metallic layer includes a first metallic region with U-shaped indents, a second metallic region, and metallic strips. Each metallic strip is inserted into a U-shaped indent, where a distance between one side of the U-shaped indent and one side of the metallic strip is shorter than that between a side of the metallic strip and a bottom of the U-shaped indent. The second metallic region is under the first metallic region. Etching the first metallic layer to adjust a length of the metallic strip, or etching the second metallic layer to adjust a width of the second metallic layer is proposed to adjust a length of the overlap of the second metallic layer and each metallic strip.

### BACKGROUND OF THE INVENTION

1. Field of the Invention

The present invention relates to a gate driver used in a flat display panel, and more particularly, to a gate driver used in a flat display panel applying GIP (gate-in-panel) technology.

2. Description of Prior Art

With a rapid development of monitor types, novel and colorful monitors with high resolution, e.g., liquid crystal displays (LCDs), are indispensable components used in various electronic products such as monitors for notebook computers, personal digital assistants (PDAs), digital cameras, and projectors. The demand for the novelty and colorful monitors has increased tremendously.

In order to reduce manufacturing cost, a panel with a glass substrate having a scan-driving circuit directly integrated thereon, called a gate-in-panel (GIP) type panel, has come to the market. A row of GIP output stages at one lateral edge of the panel applying GIP technology sequentially output waveforms of scanning signals from top to bottom to gate lines on a display area to replace traditional gate drivers. Please refer to FIG. 1, which is an equivalent circuit diagram of each of the GIP output stages 50. The GIP output stage 50 is used for charging the gate line, so a pull-up transistor T1 of the GIP output stage 50 has to supply high current. If the pull-up transistor T1 cannot supply sufficient current (i.e., poor output capability of components), the GIP output stage 50 cannot operate normally, which causes that the panel cannot display images normally. In addition to output capability, power consumption, another feature of the GIP output stage 50, has to be notified as well. The GIP output stage 50 generates larger power consumption in response to a clock signal CLK. The power consumption also depends on the capacitive load of the gate line.

Referring to FIG. 2 illustrating a layout of a pull-up transistor T1 of the GIP output stage 50, considering all the capacitive loads of the pull-up transistor T1, the capacitance C_{gd} between a metallic layer SD (slash region) and a metallic layer GE (dot region) is largest, and thus is the main factor affecting power consumption.

A commonly-used method for increasing the output current of the GIP output stage 50 is to increase the width to length ratio (W/L) of the pull-up transistor T1. But such a method also enlarges the capacitance C_{gd} and increases power consumption. So, a tradeoff between output capability and power consumption exists. Generally speaking, a modification of the GIP layout of a mask is conducted to adjust the size of the pull-up transistor T1 whenever the output capability or power consumption of the GIP needs adjusting. For a product designed for low-temperature application, the W/L ratio of the pull-up transistor T1 has to be increased to make the product function well. This is because the current of the product decreases when temperature lowers. For a product (e.g., a notebook computer) designed for low power consumption, the W/L ratio of the pull-up transistor T1 has to be decreased to reduce the power consumption.

However, there is no space reserved for modifying the W/L ratio of the pull-up transistor T1 if the output capability or power consumption of the pull-up transistor T1 output needs modifying, so a five-mask process has to be reused to design the layout of the pull-up transistor T1.

### SUMMERY OF THE INVENTION

It is therefore an object of the present invention is to provide a gate driver used in a display panel capable of adjusting power consumption and output capability. The gate driver comprises a first metallic layer and a second metallic layer. The first metallic layer comprises a first metallic region, a second metallic region, and a plurality of metallic strips. The first metallic region comprises a plurality of U-shaped indents. The plurality of metallic strips protrude out of the second metallic region, each of the metallic strips being correspondingly engaged into one of the U-shaped indents. A distance between one lateral edge of the metallic strip and one lateral edge of the U-shaped indent is shorter than the distance between the top edge of the metallic strip and the bottom edge of the U-shaped indent. The second metallic layer is disposed under the first metallic layer. A mask process is conducted on the first metallic layer for adjusting each metallic strip to modify a length of an overlap of the second metallic layer and each of the metallic strips, wherein the overlap of the second metallic layer and each of the metallic strips forms a capacitance of a pull-up transistor.

In one aspect of the present invention, the first metallic region entirely overlaps the second metallic layer.

In another aspect of the present invention, the plurality of pull-up transistors are formed on a glass substrate.

It is therefore another object of the present invention is to provide a gate driver used in a display panel capable of adjusting power consumption and output capability. The gate driver comprises a first metallic layer and a second metallic layer. The first metallic layer comprises a first metallic region, a second metallic region, and a plurality of metallic strips. The first metallic region comprises a plurality of U-shaped indents. The plurality of metallic strips protrude out of the second metallic region. Each of the metallic strips is correspondingly disposed into one of the U-shaped indents. A distance between one lateral edge of the metallic strip and one lateral edge of the U-shaped indent equals to a distance between the top edge of the metallic strip and the bottom edge of the U-shaped indent. The second metallic layer is disposed under the first metallic layer. The lateral edge of the second metallic layer does not exceed the openings of the U-shaped indent. A mask process is conducted on the second metallic layer for adjusting the width of the second metallic layer to modify the length of the overlapping of the second metallic layer and each of the metallic strips; wherein the overlapping of the second metallic layer and each of the metallic strips forms a capacitance inside a pull-up transistor.

These and other objects of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an equivalent circuit diagram of each of the GIP output stages.

FIG. 2 illustrates a layout of a pull-up transistor of a conventional GIP output stage.

FIGS. 3A, 3B, and 3C show layouts of a pull-up transistor of a panel module according to a first embodiment of the present invention.

FIGS. 4A, 4B, and 4C show layouts of a pull-up transistor of a panel module according to a second embodiment of the present invention.

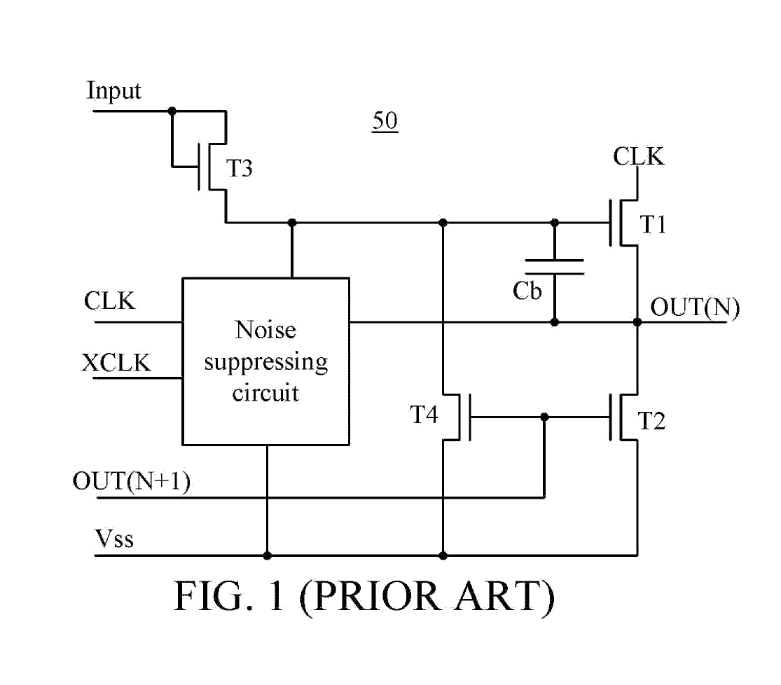

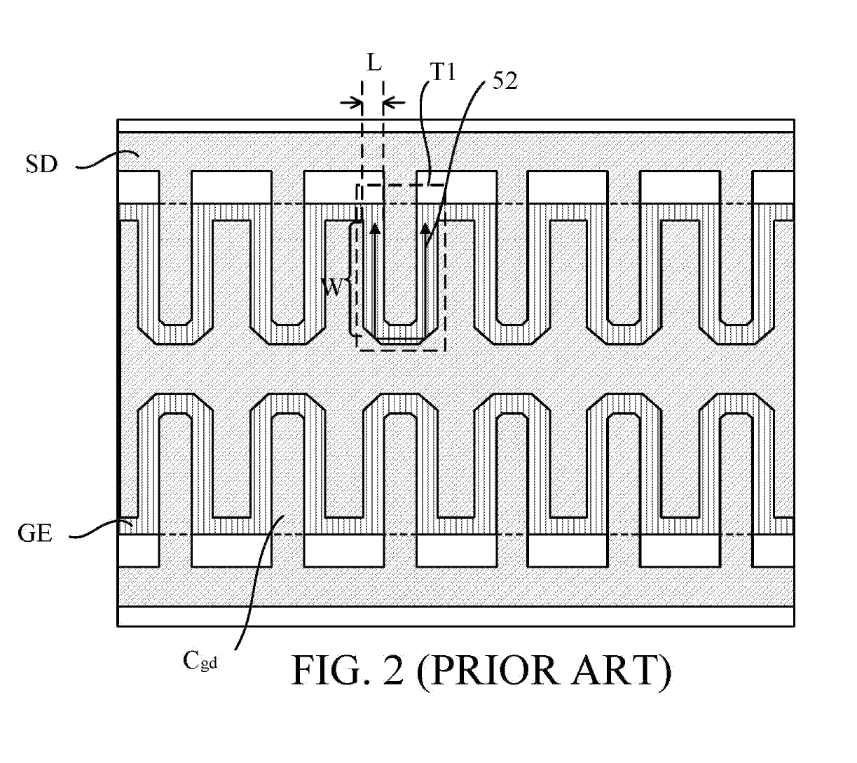

### DETAILED DESCRIPTION OF THE PREFERRED EMBODIMENTS

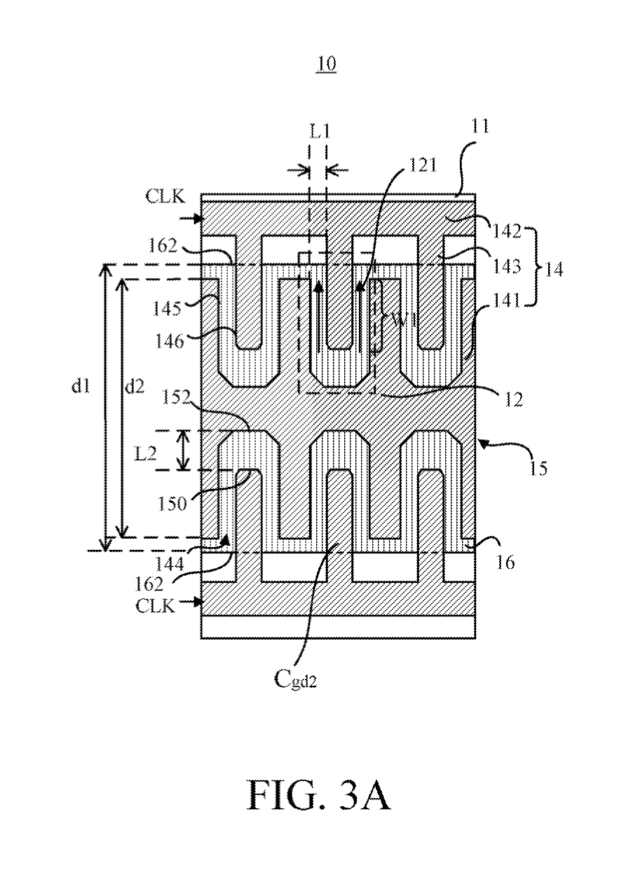

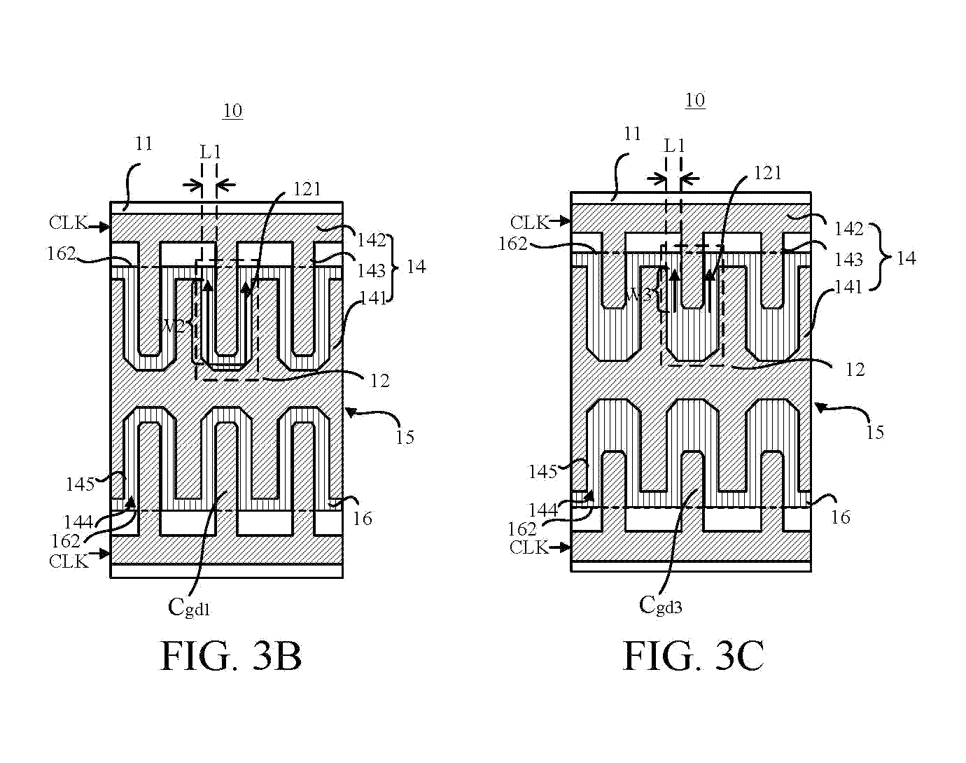

Please refer to FIGS. 3A, 3B, and 3C, which show layouts of a pull-up transistor 12 of a panel module 10 according to a first embodiment of the present invention. The panel module 10 adopting a gateless driver can adjust power consumption and output capability, so a plurality of gate lines, a plurality of pixel electrodes, and a plurality of gate drivers 15 for driving gate lines are disposed on the glass substrate 11. Each of the gate drivers 15 has to charge the entire gate line, so the pull-up transistor 12 of the gate drivers 15 has to supply high current. But when the output capability or power consumption of the gate drivers 15 requires adjustments, the panel module 10 can be easily used to modify the mask to simplify the modifications of the size of the pull-up transistor 12.

Please refer to FIG. 3A, which illustrates a first metallic layer 14 overlapping a second metallic layer 16 in the beginning The gate drivers 15 comprises a first metallic layer (slash region) 14 and a second metallic layer (dot region) 16. The first metallic layer 14 comprises a first metallic region 141, a second metallic region 142, and a plurality of metallic strips 143. The first metallic region 141 comprises a plurality of U-shaped indents 144. The second metallic region 142 is electrically connected to the drain of the pull-up transistor 12 for transmitting a clock signal CLK. The metallic strips 143 protrude out of the second metallic region 142. Each of the metallic strips 143 is correspondingly engaged into one of the U-shaped indents 144. The second metallic layer 16 is disposed under the first metallic layer 14. The U-shaped indents 144 of the first metallic layer 14 do not cover the second metallic layer 16, so part of the second metallic layer 16 is exposed.

Please refer to FIG. 3A. The distance L1 between the two lateral edges 146 of the metallic strip 143 and the two lateral edges 145 of the U-shaped indent 144 is shorter than the distance L2 between the top edge 150 of the metallic strip 143 and the bottom edge 152 of the U-shaped indent 144 for the initial state. That the distance L1 is shorter than the distance L2 allows modifications in the future. The overlap of the second metallic layer 16 and each of the metallic strips 143 forms capacitances C_{gd2} of the pull-up transistor 12. The lateral edges 162 of the second metallic layer 16 exceed the openings of the U-shaped indent 144; that is, the width dl of the second metallic layer 16 is wider than the width d2 of the first metallic region 141. So, the first metallic region 141 entirely overlaps the second metallic layer 16.

The output current (i.e., output capability) of the pull-up transistor 12 is associated with the width and the length L1 of a channel 121. For a larger output capability of the pull-up transistor 12, a mask process can be conducted on the first metallic layer 14 to adjust the length of the plurality of the metallic strips 143 for elongating the length of the overlap of the second metallic layer 16 and each of the metallic strips 143. As shown in FIG. 3B, the length of the overlap of the second metallic layer 16 and the metallic strip 143 becomes longer, so the width W2 of the channel 121 is wider than the width W1 of the channel 121 in the FIG. 3A. Thus, the output capability (i.e., output current) of the pull-up transistor 12 in FIG. 3B is larger than that in FIG. 3A. But a capacitance C_{gd1} formed at the overlap of the second metallic layer 16 and the metallic strip 143 in FIG. 3B is larger than a capacitance C_{gd2} in FIG. 3A, causing that power consumption produced by the capacitance C_{gd1} is higher than the capacitance C_{gd2}.

On the contrary, a mask process is conducted on the first metallic layer 14 for adjusting the length of the metallic strip 143 to shorten the length of the overlap of the second metallic layer 16 and each of the metallic strips 143 once the pull-up transistor 12 needs lower power consumption. As shown in FIG. 3C, the length of the overlap of the second metallic layer 16 and each of the metallic strips 143 is shorter, so the width W3 of the channel 121 is shorter than the width W1 in the FIG. 3A. So the output capability (i.e., output current) of the pull-up transistor 12 in FIG. 3C is smaller than that in FIG. 3A. But a capacitance C_{gd3} formed at the overlap of the second metallic layer 16 and the metallic strip 143 in FIG. 3C is smaller than a capacitance C_{gd2} in FIG. 3A, which causes that power consumption produced by the capacitance C_{gd3} is lower than the capacitance C_{gd2}.

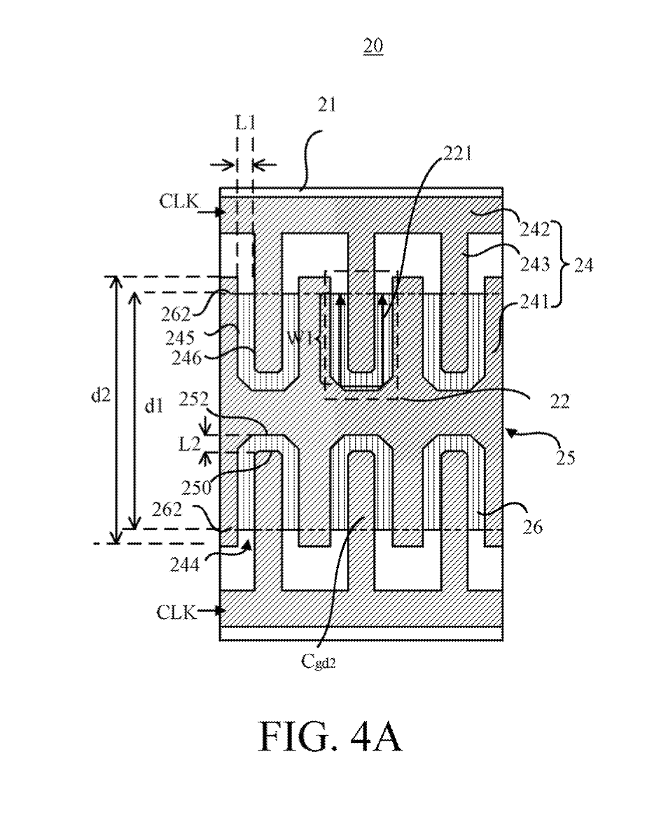

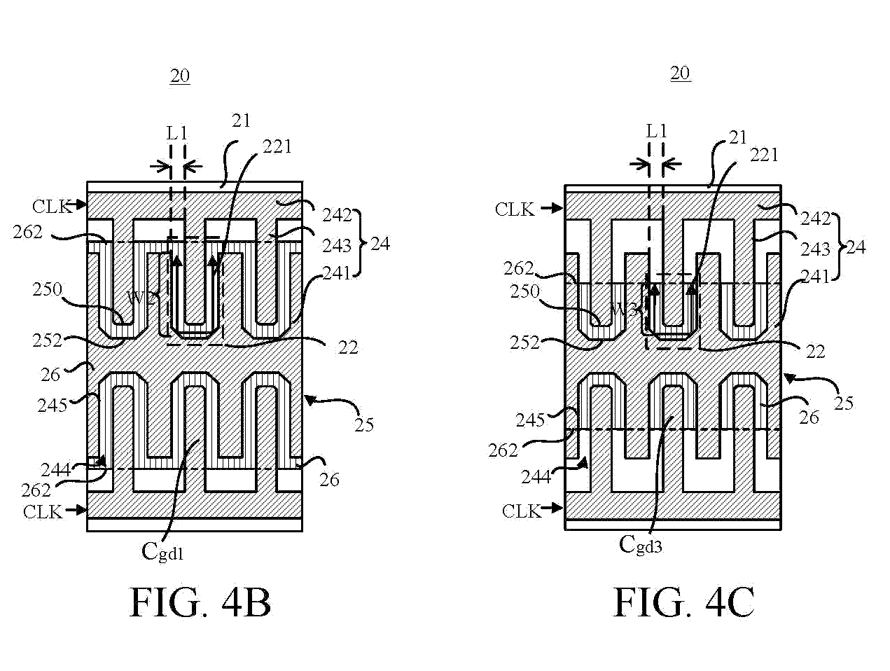

Please refer to FIGS. 4A, 4B, and 4C, which are a set of the local layout diagram of a pull-up transistor 22 of a panel module 20 according to the second embodiment in the present invention. The panel module 20, used to adjust power consumption and output capability, adopts a gateless driver. A plurality of gate lines, a plurality of pixel electrodes, and a plurality of gate drivers 25 for driving gate lines are disposed on the glass substrate 21. Each of the gate drivers 25 has to charge the entire gate line, so the pull-up transistor 22 of the gate drivers 25 has to supply high current. But when the output capability or power consumption of the gate drivers 25 requires adjustments, the panel module 20 of the present embodiment can be easily used to modify the mask to simplify the modifications of the size of the pull-up transistor 22.

Please refer to FIG. 4A. FIG. 4A illustrates a first metallic layer 24 overlapping a second metallic layer 26 in the beginning The gate drivers 25 comprises a first metallic layer (slash region) 24 and a second metallic layer (dot region) 26. The first metallic layer 24 comprises a first metallic region 241, a second metallic region 242, and a plurality of metallic strips 243. The first metallic region 241 comprises a plurality of U-shaped indents 244. The second metallic region 242 is electrically connected to the drain of the pull-up transistor 22 for transmitting a clock signal CLK. The metallic strips 243 protrude out of the second metallic region 242. Each of the metallic strips 243 is correspondingly disposed into one of the U-shaped indents 244. The second metallic layer 26 is disposed under the first metallic layer 24.

The distance L1 between the two lateral edges 246 of the metallic strip 243 and the two lateral edges 245 of the U-shaped indent 244 is equal to the distance L2 between the top edge 250 of the metallic strip 243 and the bottom edge 252 of the U-shaped indent 244 for the initial state. The overlaps of the second metallic layer 26 and each of the metallic strips 243 form capacitances C_{gd2} of the pull-up transistor 12. The lateral edges 262 of the second metallic layer 26 do not exceed the openings of the U-shaped indent 244; that is, the width d1 of the second metallic layer 26 is shorter than the width d2 of the first metallic region 241. So, the second metallic layer 26 only partially overlaps the first metallic region 241.

The output current (i.e., output capability) of the pull-up transistor 22 is associated with the width W1 and the length L1 of a channel 221. When the pull-up transistor 22 needs larger output capability, a mask process can be conducted on the second metallic layer 26 to adjust the width of the second metallic region 242 for elongating the length of the overlapping of the second metallic layer 26 and each of the metallic strips 243. As shown in FIG. 4B, the length of the overlap of the second metallic layer 26 and each of the metallic strips 243 is longer, so the width W2 of the channel 221 is wider than the width W1 of the channel 221 in the FIG. 4A. Thus, the output capability (i.e., output current) of the pull-up transistor 22 in FIG. 4B is larger than that in FIG. 4A. But a capacitance C_{gd1} formed at the overlap of the second metallic layer 26 and the metallic strip 243 in FIG. 4B is larger than a capacitance C_{gd2} in FIG. 4A, causing that power consumption produced by the capacitance C_{gd1} is higher than the capacitance C_{gd2}.

On the contrary, a mask process is conducted on the second metallic layer 26 for adjusting the width of the second metallic layer 26 to shorten the length of the overlap of the second metallic layer 26 and each of the metallic strips 243 once the pull-up transistor 22 needs lower power consumption. As shown in FIG. 4C, the length of the overlapping of the second metallic layer 26 and each of the metallic strips 243 is shorter, so the width W3 of the channel 221 is shorter than the width W1 in the FIG. 4A. So the output capability (i.e., output current) of the pull-up transistor 22 in FIG. 4C is smaller than that in FIG. 4A. But a capacitance C_{gd3} formed at the overlapping of the second metallic layer 26 and the metallic strip 243 in FIG. 4C is smaller than a capacitance C_{gd2} in FIG. 4A, which causes that power consumption produced by the capacitance C_{gd3} is lower than the capacitance C_{gd2}.

Compared with the prior art, the length of the metallic strip of the first metallic layer or the width of the second metallic layer of the panel module of the present invention can be modified through a one-mask process. Thus, the W/L ratio of the pull-up transistor or the size of the capacitance can be altered. This means that, the one-mask process can be successfully applied to diverse product specifications once the output capability and power consumption of the gate driver of the panel module of the present invention requires modifications in the future. It shows that the panel module of the present invention provides greater design flexibility.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A gate driver used in a display panel comprising:
a first metallic layer, comprising a first metallic region, a second metallic region, and a plurality of metallic strips, the first metallic region comprising a plurality of U-shaped indents, the plurality of metallic strips protruding out of the second metallic region, each of the metallic strips being correspondingly engaged into one of the U-shaped indents; a distance between one lateral edge of the metallic strip and one lateral edge of the U-shaped indent being shorter than the distance between the top edge of the metallic strip and the bottom edge of the U-shaped indent; and
a second metallic layer, being disposed under the first metallic layer;
wherein a mask process is conducted on the first metallic layer for adjusting each metallic strip to modify a length of an overlap of the second metallic layer and each of the metallic strips, wherein the overlap of the second metallic layer and each of the metallic strips forms a capacitance of a pull-up transistor.

2. The gate driver of claim 1 wherein the first metallic region entirely overlaps the second metallic layer.

3. The gate driver of claim 1 wherein the plurality of pull-up transistors are formed on a glass substrate.

4. A gate driver used in a display panel comprising:
a first metallic layer, comprising a first metallic region, a second metallic region, and a plurality of metallic strips, the first metallic region comprising a plurality of U-shaped indents; the plurality of metallic strips protruding out of the second metallic region, each of the metallic strips being correspondingly disposed into one of the U-shaped indents, a distance between one lateral edge of the metallic strip and one lateral edge of the U-shaped indent being equal to a distance between the top edge of the metallic strip and the bottom edge of the U-shaped indent; and
a second metallic layer, disposed under the first metallic layer, the lateral edges of the second metallic layer not exceeding the openings of the U-shaped indent;
wherein a mask process is conducted on the second metallic layer for adjusting the width of the second metallic layer to modify the length of the overlapping of the second metallic layer and each of the metallic strips; wherein the overlapping of the second metallic layer and each of the metallic strips forms a capacitance inside a pull-up transistor.

5. The gate driver of claim 4 wherein the plurality of pull-up transistors are formed on a glass substrate.

6. The gate driver of claim 4 wherein part of the first metallic layer is overlapped with the second metallic layer.
